(19) United States
(12) Patent Application Publication
(10) Pub. No.: US 2012/0064341 A1
(43) Pub. Date: Mar. 15, 2012

(54) CARBON NANOTUBE/METAL CARBIDE COMPOSITES WITH ENHANCED PROPERTIES

(75) Inventors: Guifu Zou, Suzhou (CN); Yingying Zhang, Beijing (CN); Anthony Keiran Burrell, Naperville, IL (US); Thomas Mark McCleskey, Los Alamos, NM (US); Quanxi Jia, Los Alamos, NM (US)

(73) Assignee: LOS ALAMOS NATIONAL SECURITY, LLC, Los Alamos, NM (US)

(21) Appl. No.: 13/240,071

(22) Filed: Sep. 22, 2011

Related U.S. Application Data
(63) Continuation-in-part of application No. 12/697,877, filed on Feb. 1, 2010.

(51) Int. Cl. H01B 1/04; D02G 1/02; D02G 3/02; B82Y 30/00; B82Y 40/00

(52) U.S. Cl. 428/367; 252/504; 264/103; 977/752

(57) ABSTRACT

Composite structures of carbon nanotubes (CNTs) and metal carbides include a helical nanotube/carbide composite fiber, and a film. The composite fiber was prepared by pulling/twisting carbon nanotubes from an array of nanotubes to form an as-spun fiber and soaking it a metal precursor solution, and then heating it under a reducing atmosphere with a carbon source. The composite fiber had a higher tensile strength, a higher conductivity, and a higher tensile modulus than the as-spun fiber. A composite structure in the form of parallel ribbons of aligned carbon nanotubes embedded in a film of NbC showed an enhanced conductivity along the CNT axial direction, and improved superconducting properties. The enhanced upper critical field of NbC/CNT suggested that the inclusion of CNTs in the NbC matrix reduced the coherence length of the NbC. Nanomechanical testing also demonstrated the potential for enhanced fracture toughness of NbC/CNT composites.

### RELATED APPLICATIONS

This application is a continuation-in-part of U.S. patent application Ser. No. 12/697,877 entitled “Preparation of Metal Carbide Films,” filed Feb. 1, 2010, hereby incorporated by reference.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates to the preparation of composites of carbon nanotubes and metal carbides.

### BACKGROUND OF THE INVENTION

Carbon nanotubes (CNTs) have a high mechanical strength, high stiffness, and good electrical conductivity [1-3], but they typically can be grown in lengths too short to take full advantage of these properties. Longer fibers have been assembled from much shorter nanotubes, but these fibers have low mechanical strengths and low electrical conductivities [4-6]. Efforts at improving these properties have involved preparing composite materials of the nanotube fibers with various materials including polymer, silica, or gold. The reported mechanical strengths and electrical conductivities of these composite materials were still low [7,8]. Composites of CNTs with enhanced properties remain desirable.

### SUMMARY OF THE INVENTION

The present invention provides a composite structure comprising a solid mixture of aligned multiwalled carbon nanotubes and metal carbide. Embodiments include helical fibers and films.

The invention is also concerned with a composite structure of multiwalled carbon nanotubes and metal carbide prepared by a process comprising: drawing carbon nanotubes from an array of substantially aligned carbon nanotubes while twisting the carbon nanotubes around each other to form a helical fiber, coating the carbon nanotubes from the fiber with a homogeneous solution comprising a soluble metal precursor, a soluble polymer selected from a polyethyleneimine and derivatives of polyethyleneimine, and a suitable solvent, the soluble metal precursor including a metal selected from titanium, zirconium, hafnium, vanadium, niobium, tantalum, chromium, molybdenum, tungsten, scandium, yttrium, aluminum and silicon, the soluble polymer binding to the soluble metal precursor, and thereafter heating the fiber in a reducing atmosphere that includes a carbon source gas under conditions suitable for removing the polymer and forming a composite structure of multiwalled carbon nanotubes and metal carbide, said composite structure comprising a composite helical fiber of carbon nanotubes and metal carbide. The coating step may involve soaking the helical fiber of carbon nanotubes in the homogeneous solution. The homogeneous solution includes a suitable soluble metal-containing precursor and a soluble polymer all dissolved in a suitable solvent.

The invention is also concerned with a process for forming a composite structure, comprising: drawing carbon nanotubes from an array of substantially aligned carbon nanotubes while twisting the carbon nanotubes around each other to form a helical fiber, coating the carbon nanotubes from the fiber with a homogeneous solution comprising a soluble metal precursor, a soluble polymer selected from a polyethyleneimine and derivatives of polyethyleneimine, and a suitable solvent, the soluble metal precursor including a metal selected from titanium, zirconium, hafnium, vanadium, niobium, tantalum, chromium, molybdenum, tungsten, scandium, yttrium, boron, aluminum and silicon, the soluble polymer binding to the soluble metal precursor, and thereafter heating the fiber in a reducing atmosphere that includes a carbon source gas at temperatures and for times characterized as sufficient to remove the polymer and form a structure comprising a composite helical fiber of carbon nanotubes and metal carbide

### BRIEF DESCRIPTION OF THE DRAWINGS

FIG. 1 shows an X-ray diffraction pattern of an embodiment helical composite CNT/TiC fiber.

FIG. 2a compares the tensile strengths of an as-spun helical fiber with an embodiment helical CNT/TiC composite fiber, while FIG. 2b shows a highly magnified image of a tip of a helical composite CNTITiC fiber after tensile failure.

FIG. 3 shows the temperature dependence of the resistivity for both the as-spun CNT fiber and the helical CNT/TiC composite fiber from 50 K to 300 K, measured by a four-probe method.

FIGS. 4a and 4b show the conduction mechanism for an embodiment helical CNT/TiC composite fiber of the present invention.

FIG. 5 shows a schematic illustration of the processing steps to synthesize NbC/CNT composite: (1) spin-coating precursor Nb solution on c-cut Al₂O₃; (2) annealing the precursor film in ethylene to form NbC film; (3) laying aligned CNT ribbon on the NbC film; (4) spin-coating the 2^{nd} precursor Nb solution; and (5) annealing the composite film in ethylene and forming gas.

FIG. 6 shows X-ray diffraction patterns of the NbC/CNT composite on c-cut Al₂O₃ substrate: (a) 0-20 scans, where inset shows the rocking curve of (111) reflection of NbC film; (b) φ-scans from (200) reflection of NbC film and (113) of Al₂O₃.

FIG. 7 shows (a) SEM image of the CNT ribbon. (b) TEM image of the CNT ribbon and a typical high-resolution TEM image of an individual CNT (inset). (c) SEM image (top view) of the NbC/CNT composite film.

FIG. 8 shows temperature dependence of the upper critical field (H_{c2}) of the NbC/CNT composite film and the pure NbC film on sapphire substrate. Inset: Normalized resistivity at different magnetic fields as a function of temperature for a typical NbC/CNT composite film. The magnetic field is applied perpendicular to the film and the resistivity is measured in the direction parallel to CNTs.

FIG. 9 shows temperature dependence of the resistivities of a NbC/CNT film measured when the current is applied along different directions of the CNTs.

FIG. 10 shows SEM image of NbC/CNT after nano-indentation to a depth of 1 μm. Fracture of the film is evident, with carbon nanotubes decorating the edge of the fracture surface. Inset shows evidence of CNT crack bridging as marked by arrows, which is a toughening mechanism that can lead to enhanced fracture toughness.

### DETAILED DESCRIPTION

The present invention is concerned with the preparation of composite structures that include carbon nanotubes and metal carbide. An aspect of the invention relates to the preparation of an embodiment structure that is a composite helical fiber carbon nanotubes and metal carbide. An embodiment process for preparing such a structure involves forming a helical fiber of carbon nanotubes by pulling nanotubes from a supported array while twisting them around each other to form a fiber, coating the fiber in a homogeneous solution of polymer and metal containing precursor, and heating the coated fiber. Coating should be sufficient to coat nanotubes on both inside and outside the fiber. This may be accomplished by, for example, soaking the fiber in the homogeneous solution. The coated fiber is heated under a reducing atmosphere to evaporate the solvent, decompose the polymer, and form metal carbide. Metal carbides are very hard materials with a high temperature stability, low electrical resistivity, and high resistance to corrosion and oxidation. Titanium carbide, for example, shows excellent hardness, high Young's modulus, low coefficient of friction, and good oxidation resistance. Niobium carbide has high hardness, an extremely high melting temperature (3600K). Suitable metal-containing precursors for the formation of metal carbides include compounds of various transition metals such as titanium, zirconium, hafnium, vanadium, niobium, tantalum, chromium, molybdenum, tungsten, scandium, and yttrium. Titanium carbide is a preferred metal carbide. Suitable aluminum-containing precursors may also be used for forming helical fiber composites of carbon nanotubes with aluminum carbide. Helical fiber composites may include carbides of the lanthanides and actinides by the same process using suitable lanthanide or actinide containing precursors.

Fibers were prepared using a supported dense array of highly aligned carbon nanotubes. The nanotubes of such arrays are known to be multiwalled carbon nanotubes. The CNT arrays were synthesized in a 2.54 cm diameter quartz tube furnace. A thin layer of Fe (about 1.0 nm) catalyst film was deposited on Al₂O₃ (about 10 nm) on SiO₂ (about 1 μm) coated Si wafers. Forming gas (Ar with 6% H₂) was used as carrier gas, and ethylene served as carbon source. The growth of CNTs was carried out at 750° C. for 10 min with 140 sccm forming gas and 30 sccm ethylene gas.

In an embodiment, after soaking the as-spun fiber in a solution of metal-containing precursor and polymer, the coated fiber is heated under a reducing atmosphere of forming gas, which is a gas made up from about 90% to about 99% argon and from about 1% to about 10% H₂. An embodiment forming gas includes 6% hydrogen and the rest argon. Hydrogen is the reducing agent. The heating continues until the solvent is evaporated and the polymer decomposes, after which the carbon source is added and the temperature is increased so that the carbon source gas can react with the metal to produce the metal carbide. The structure can be annealed at still higher temperature.

Suitable gaseous carbon sources include hydrocarbons such as, but not limited to, ethylene, methane, acetylene, and alcohols such as, but not limited to, ethanol. The soluble polymer used in the present process binds to the metal precursors through any of various mechanisms such as electrostatic attraction, hydrogen bonding, covalent bonding and the like. The polymers should be soluble, compatible with the metal precursors, and also undergo a clean decomposition upon heating at high temperatures, e.g., temperatures over about 250° C. Preferred soluble polymers include polyethylenimine (PEI) and PEI derivatives such as a carboxylated-polyethylenimine (PEIC), a phosphorylated-polyethylenimine (PEIP), a sulfonated-polyethylenimine (PETS), an acylated-polyethylenimine, hydroxylated water-soluble polyethylenimines and the like. The soluble polymer can also be a polymer such as polyacrylic acid, polypyrolidone, and poly(ethylene-maleic acid). Because PEI decomposes completely and cleanly above 250° C. and leaves little or no residual carbon in the film, PEI and PEI derivatives are preferred polymers. Typically, the molecular weight of such polymers is greater than about 30,000.

The solutions of soluble polymer and metal precursor that are used in depositing the polymer and metal on the substrates are homogeneous solutions. By “homogeneous” is meant that the solutions are not dispersions or suspensions, but are actual solutions of the polymer, metal complexes and any metal binding ligands.

The soluble polymer, besides aiding in the deposition, also aids in attaining a suitable viscosity for allowing processing of the metal carbide precursor solution into a film that coats the nanotubes. The desired viscosity can be achieved through controlling the solution concentration of the soluble polymers and by controlling the molecular weight of the polymer. For high quality homogeneous films, polymer concentrations and the polymer ratio to metal components should be maintained at a proper balance. The rheology of the metal carbide precursor solution can also be important for the morphology and quality of the final composite.

The soluble polymer also functions as binding agent to metal in the precursor solution in assisting the formation of polymer-and-metal containing film that coats the nanotubes and ultimately a metal carbide matrix in which the nanotubes are embedded. The polymer should have suitable interactions with metal ions that prevent phase separation during the coating process. Thereafter, the coated nanotubes are heated at high temperatures (calcined), e.g., at temperatures above about 450° C. to obtain the metal carbide composite. The soluble polymer selection should also have a clean decomposition under such calcination conditions so that the final metal carbide film can be free of side products.

The composites prepared by the present process can include a metal carbide with a single metal, can be a metal carbide with two metals or three metals or may be a metal carbide including four or more metals. Among the metal carbides that can be prepared by the present process are included metal carbides from transition metals, silicon, and aluminum. These carbides include silicon carbide, titanium carbide, niobium carbide, vanadium carbide, tungsten carbide, and tantalum carbide. Composites with two metals are also possible, which include, for example, titanium carbide/niobium carbide, titanium carbide/vanadium carbide, titanium carbide/tantalum carbide, niobium carbide/vanadium carbide, niobium carbide/tantalum carbide, vanadium carbide/tantalum carbide, and the like. Composites with three metals may include titanium carbide/niobium carbide/vanadium carbide. Composites with four metals may include titanium carbide/niobium carbide/vanadium carbide/tantalum carbide.

The solvent for dissolution of the soluble polymer can be, e.g., water, lower alcohols such as methanol, ethanol, propanol and the like, acetone, propylene carbonate, tetrahydrofuran, acetonitrile, acetic acids and mixtures thereof such as water and ethanol and the like. As the soluble polymer used in the present invention includes binding properties for the metals or metal precursors used in formation of the metal carbide films, the polymer can help provide the necessary solubility to the respective metals, e.g., metal precursors.

The starting solution is typically maintained at ambient temperatures from about 15° C. to about 30° C., more usually from about 20° C. to about 25° C. Within those temperature ranges and above the higher temperature, the materials added to the solution are soluble. In preparation of solutions used in the present process, the solutions using a polyethylenimine as the metal binding polymer can be filtered prior to use to remove any non-soluble components. Typically, a precursor solution of containing metal and a polyethyleneimine is filtered using an Amicon ultrafiltration unit containing an untrafiltration membrane designed to pass materials having a molecular weight of less than about 3,000 g/mol (e.g., unbound metal, smaller polymer fragments and the like) while retaining the desired materials of a larger size. Ultrafiltration allows for removal of any unwanted salts such as cations, anions or other impurities.

The metal ratio can be controlled through appropriate addition of metal precursors to a solvent used in the deposition. Such solutions can generally have a shelf life of months or more than a year.

The homogeneous coating solution can be coated onto the nanotubes by any coating procedure that allows the solution to penetrate the as-spun fiber and coat nanotubes in the fiber. Dip coating or soaking in the solution allows this to happen. Afterward, the coated nanotubes are heated at high temperatures (i.e. calcined) of from about 250° C. to about 1300° C., preferably from about 400° C. to about 1200° C. for a period of time sufficient to remove the polymer and to form the metal carbide composite. Heating times may be varied and may be longer depending upon the thickness of the deposited film.

Optionally, the coated nanotubes may be initially dried by heating to temperatures of from about 50° C. to about 150° C. for from about 15 minutes to several hours. The coated nanotubes undergo removal of a percentage of volatile species, mostly water, during such an initial drying stage.

The polymer is used to bind metals and metal precursors. This allows the removal of any unwanted anions or cations by filtration, e.g., through an Amicon ultrafiltration unit, and brings multiple metals together in a homogeneous manner at a molecular level. This also prevents selective precipitation of unwanted metal phases as a portion of the water can be removed and the metals concentrated within the remaining solution. The present invention can control the relative metal concentrations at the molecular level for mixed metal carbides (TiC/NbC, for example). This can be done, for example, by adding a single polymer (such as carboxylated polyethyleneimine) to a solution containing simple salts (such as nitrate) of two or more metals in the correct ratio. If the binding constant is high for both metals then they will remain in the correct ratio during filtration and concentration of the polymer. Alternatively, each metal can be bound to a polymer, and then the metals can be mixed and the resulting solution can be concentrated and then examined by ICP to determine metal content and then mixed appropriately prior to spin coating. Different polymers and different solvents can be used for different metals in this system.

A speed-adjustable drill equipped with a metal tip and a layer of sticky tape was used to spin nanotubes from the array into a fiber. Initially, the sticky tip pulled a bundle of CNTs away from the CNT arrays into an untwisted ribbon. Then the drill was pulled away from CNT arrays at a speed of 5 mm/min while rotating at 1500 rpm. After a 10 cm long fiber was obtained, the pulling was stopped, but the rotation was kept at 1500 rpm for 3 min.

In an embodiment, a solution including a titanium-containing precursor was prepared. The solution was made by adding 12 g of hexafluorotitanic acid H₂TiF₆ (Aldrich 99.9%; 60 wt % in water) to a solution of 7.5 g polyethyleneimine (PEI) (BASF Corporation of Clifton, N.J., used without further purification) and 40 milliliters of water (18 MΩ·cm). The solution was purified by ultrafiltration using Amicon stirred cells and 3,000 molecular weight cut-off ultra filtration membrane under 60 psi argon pressure. The concentration of titanium in the precursor solution was determined using a HORIBA JOBIN YVON ULTIMA II inductively coupled plasma-atomic emission spectrometer (ICP-AES). This analysis showed that the final solution was 496 millimolar (mM) in Ti.

A 5-cm long CNT fiber prepared as described above was soaked in the Ti precursor solution for 5 minutes, then removed from the solution and loaded into a quartz furnace and heated to 650° C. at a rate of 10° C./min in a flowing gaseous atmosphere consisting of a mixture of ethylene (10 sccm) and forming gas (10 seem). After annealing the fiber at 650° C. for 1 hour, this gas flow was stopped and replaced with an argon gas flow at a rate of 10 seem, and the furnace was ramped to 1000° C. in one hour, and the sample was annealed at 1000° C. for 3 hours, after which the power supply to the furnace was turned off and the furnace was allowed to cool to room temperature.

The morphologies of the as-spun fiber (prior to treatment with the homogeneous solution of metal-containing precursor) and the composite fiber were were analyzed by scanning electron microscopy (SEM). Highly magnified images using SEM showed tightly wound helical fibers with some loose strands dangling around the as-spun fiber. A composite fiber of carbon nanotubes and titanium carbide is (TiC) appeared from the images to be smoother with a more compact surface than the as-spun fiber. The surface morphologies of both the as-spun fiber and the composite fiber were helical, which suggested that the metal carbide was embedded in the fiber. The as-spun helical CNT fiber was wider (i.e. had a larger diameter) than the helical composite CNT/TiC fiber. The diameter of the CNT/TiC composite fiber was 4.5 micrometers (μm) while the diameter of the as-spun fiber was 6.5 μm. One would have expected the helical composite fiber to be wider if the metal carbide were coated only on the outside of the fiber. Without wishing to be bound to any particular theory of explanation, the composite fiber might be narrower due to a cross-linked network in the composite. Crosslinks could enhance the mechanical strength of the composite fiber.

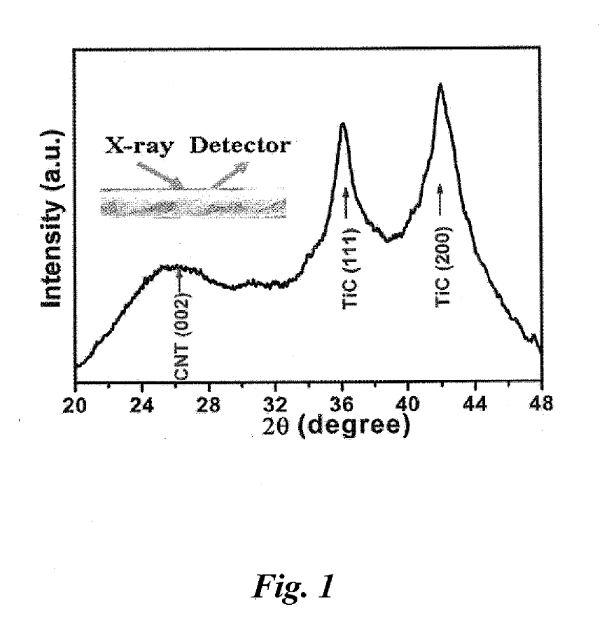

The structure of an embodiment helical CNT/TiC composite fiber was examined by x-ray diffraction (XRD). FIG. 1 shows an X-ray diffraction pattern of this composite fiber. The diffraction pattern includes three main peaks. Two of these peaks are relatively sharp. These peaks were assigned to TiC (111) and (200) planes. The spectrum also included a relatively broad peak at a 2θ angle of 25.9° that was assigned to the CNT (002) plane. The spectrum did not show a well-defined peak at a 2θ angle of around 42.1°, which if observed in the past for materials that included CNTs had been assigned to a CNT (100) diffraction. The absence of this peak suggests that the CNTs in the composite fiber are well aligned (along the axial direction).

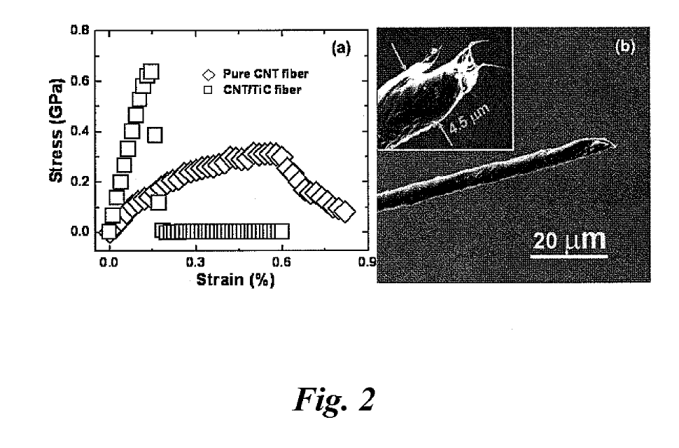

Individual CNTs have a very high tensile strength, higher than for steel. However, because the forces between individual tubes are relatively weak van der Waals forces, it is difficult to fabricate fibers made only from CNT fibers. An aspect of this invention relates to an improvement in the strength by incorporating metal carbides into helical fibers of CNTs. Composite fibers of carbon nanotubes and metal carbide show much improved mechanical strength compared to the as-spun fibers. FIG. 2 shows a graph comparing the tensile strengths of an as-spun helical CNT fiber with an embodiment helical CNT/TiC composite fiber of this invention. The mechanical measurements were carried out by SHIMADZU Mechanical Testing Machine. As FIG. 2 shows, the tensile strength of a helical as-spun CNT fiber is 0.31 GPa while that for a helical composite fiber is 0.67 GPa. The value of 0.67 GPa is higher than for other reported composite fibers [9-11]. The helical composite fiber also has a high tensile modulus of approximately 420 GPa, which is believed to be the highest value reported thus far for a composite fiber of CNTs. The embedded TiC appears to play some role in improving the tensile modulus. Titanium carbide is known to be a very hard material with a Young's modulus of around 460 GPa [12]. It may be possible to make CNT/TiC composite fibers that with a Young's modulus equal or almost equal to the Young's modulus of pure TiC.

As-spun CNT fibers have been reported to have a long tail during tensile failure tests [13]. An embodiment helical CNT/Ti composite fiber was subjected to the tensile failure test. Highly magnified images obtained using scanning electron microscopy after the failure test for the helical CNT/TiC composite fiber shows that the composite fiber undergoes an abrupt failure. The surface morphology of a broken as-spun helical CNT fiber after failure indicates that as-spun helical CNT fiber becomes thinner and thinner with increasing strain until the final failure. The loose attachment between CNTs and sliding against each other among the individual CNTs are believed to be responsible for this behavior of the as-spun fiber. By contrast, the failure for the helical composite fiber was abrupt, suggesting that the embedded TiC plays a role in minimizing the sliding problem. A possible explanation is tha the TiC and individual CNTs form a tight network that minimizes sliding amongst the individual CNTs. FIG. 2b shows a highly magnified image of a tip of helical composite CNT/TiC fiber after failure. The lack of a long narrow tail implies that sliding was minimal, in contrast to what was observed for the as-spun fiber [13]. This may also explain the observation that the helical CNT/TiC composite fiber sustains only about 0.15% strain before the fiber fractures.

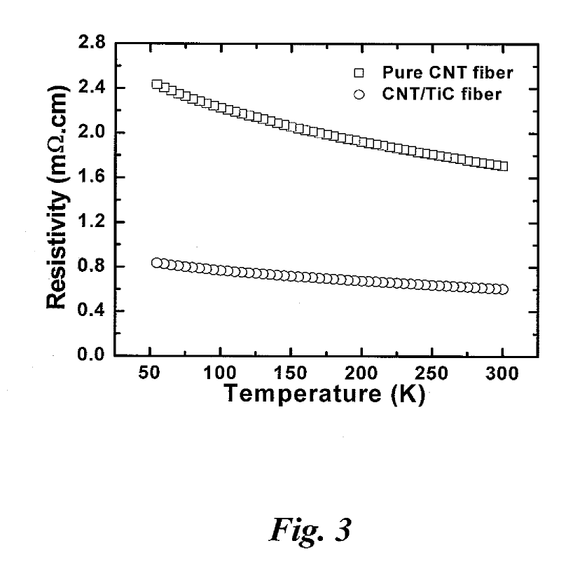

The temperature dependent resistivities of the helical as-spun CNT fiber and the helical composite CNT/TiC fiber were measured based on a standard four-probe technique using a Physical Properties Measurement System. FIG. 3 provides a graph showing the temperature dependence of the resistivity for both the pure (i.e. as-spun) CNT fiber (hollow square symbols) and the helical CNT/TiC composite fiber (hollow diamond symbols) from 50 K to 300 K, measured by a four-probe method. The resistivity of both fibers decreased as the temperature increased, but the CNT/TiC composite fiber shows a weaker temperature dependence of resistivity compared to the pure CNT fiber, perhaps because TIC is a conductive material [14].

The CNT/TiC fiber also showed much higher electrical conductivity than the as-spun fiber (i.e. the pure CNT fiber). The CNT/TiC composite fibers displayed a conductivity as high as 1650 S/cm (or a resistivity as low as 606 μΩ·cm) at room temperature. This value for the conductivity is much higher than the reported values for the CNT composites with polymer, silica, or even gold [7]. The much improved conductivity may due to a homogeneous distribution of embedded TiC that has the effect of improving electrical contact amongst the individual CNTs of the composite fiber.

To understand the conduction mechanism of a composite fiber, the temperature dependence of conductivity was analyzed. The resistivity of a helical CNT/TiC composite fiber is expected to depend on the contact resistance between CNTs and the TiC matrix, and also on the resistances of CNTs and TiC. The resistivity of a CNT fiber is often far higher than the resistivity of an individual CNT. The contact resistances play a significant role in the conduction behavior of a fiber of CNTs. Two mechanisms have been proposed to explain the conduction process of semiconductive CNTs. They are well named as variable range hopping [15] and tunneling conduction [16], and can be described with the following two equations, respectively:

σT^{1/2}=exp(−B/T^{1/4}) (1)

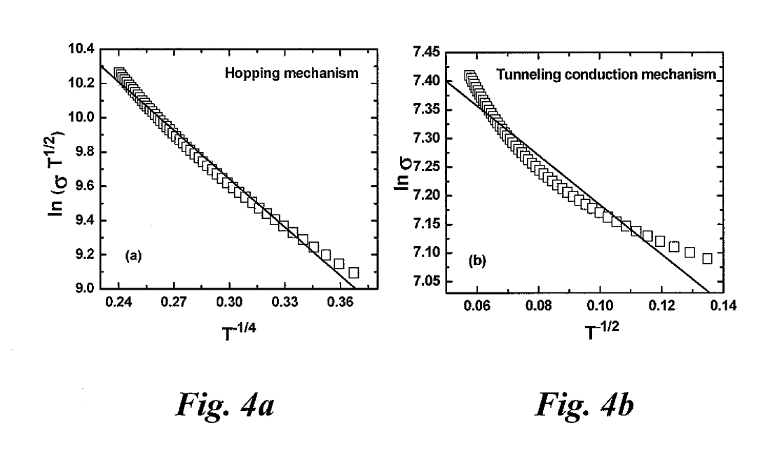

σ=exp(−A/T^{1/2}) (2)

where σ is the conductivity, σₒ, A, and B are constants, and T is the temperature. FIGS. 4a and 4b provide graphs of the data in the form of ln σT^{1/2} versus T^{1/4}, and ln σ versus T^{1/2}, based on equations (1) and (2), respectively. The data has a more linear fit in FIG. 4a than in FIG. 4b, which suggests a hopping conduction mechanism as the more likely one for the composite fiber. Further support for a hopping mechanism was obtained by examining the relationship between conductivity and temperature using the Mott's variable range hopping model [17]. The results from this analysis were consistent with a three dimensional hopping mechanism. Without wishing to be bound to any particular theory of explanation, defect structures of CNT/TiC fibers may participate in electrical conduction. Electrical conductivity for composite fibers is not confined solely in the one dimensional channel along a single CNT. In addition to this electrical conduction inside an nanotube, electrons hop from one nanotube to another.

It should be understood that this invention is not limited to titanium carbide and niobium carbide composites, and that other metal carbide composites could also be prepared. A homogeneous solution of the appropriate metal would be needed. Examples 1 and 2 below describe the preparation of homogeneous precursor solutions of titanium (Example 1) and niobium (Example 2). The other Examples illustrate the preparation of solutions besides titanium and niobium that which may be used to coat the helical CNT as-spun fiber, which can then be processed to form composite helical fibers with a corresponding metal carbide.

### Example 1

A precursor solution for preparing titanium carbide embedded CNT composite fibers was prepared as follows: 12 grams (“g”) of hexafluorotitanic acid (H₂TiF₆, ALDRICH, 99.9%, 60% in water) was added to 7.5 g of a solution of polyethyleneimine (“PEI”) (purchased from BASF CORPORATION, Clifton N.J., used without further purification) and 40 mL of water purified to 18 MΩ·cm using a MILLI-Q water treatment system. The resulting solution was purified by ultrafiltration, which was carried out using Amicon stirred cells and a 3,000 molecular weight cut-off ultrafiltration membrane under 60 psi argon pressure. Titanium analysis was conducted using a HORIBA JOBIN YVON ULTIMA II inductively coupled plasma-atomic emission spectrometer (“ICP-AES”) following the standard SW846 EPA (Environmental Protection Agency) method 6010 procedure. Analysis showed that the final Ti precursor solution was 496 millimolar (“mM”) in Ti.

### Example 2

A precursor useful for preparing niobium carbide embedded CNT composite fibers was prepared as follows: NbCl₅ (>99% pure), NH₄OH, and 20% HF were dissolved in water where the water was purified using the Milli-Q water treatment system. Ultrafiltration was carried out under 60 psi nitrogen pressure using Amicon stirred cells with a 3000 molecular weight cut-off. In detail, 2 g of NbCl₅ were converted to Nb(OH)₅ by addition of ammonium hydroxide into the solution. The Nb(OH)₅ was then dissolved in 30 mL of deionized water and 7.5 mL of 20% HF. PEI was then added in 31 g aliquots (total of 3.0 g) and mixed after each addition. After stirring, the solution was placed in an Amicon filtration unit containing a filter designed to pass materials with molecular weight<3,000 g/mol. The solution was diluted 3 times to 200 mL and then purified by ultrafiltration, which resulted in a final volume of about 35 mL in volume. Inductively coupled plasma-atomic emission spectroscopy showed that the final solution was 400 mM in Nb.

### Example 3

A precursor solution useful for preparing tantalum carbide embedded CNT composite fibers was prepared as follows: tantalum chloride was dissolved in water. Ammonium hydroxide was added, which resulted in precipitation of tantalum hydroxide (Ta(OH)₅). The precipitate was rinsed with copious amounts of deionized water to remove chloride from the precipitate. The precipitate was then dissolved in 20% HF solution to form a tantalum fluoride complex. PEI was added to this solution, and afterward, ultrafiltration was carried out using Amicon stirred cells and a 3,000 molecular weight cut-off ultrafiltration membrane under 60 psi argon pressure. Inductively coupled plasma-atomic emission spectroscopy showed that the final solution was 214 mM in tantalum.

### Example 4

A precursor solution for preparing vanadium carbide embedded CNT composite fibers was prepared as follows: 2 g sodium vanadate was dissolved in 40 ml of water containing 2 g of PEI polymer. The resulting solution was purified by ultrafiltration using Amicon stirred cells and a 3,000 molecular weight cut-off ultra filtration membrane under 60 psi argon pressure to give a solution with 134 mM for vanadium concentration as measured by inductively coupled plasma-atomic emission spectroscopy.

### Example 5

A precursor solution useful for preparing silicon carbide-embedded CNT composite fibers was prepared as follows: 12 g of fluorosilcic acid, H₂SiF₆ (25 wt % H₂SiF₆ in water) was mixed with 3.0 g PEI in 40 mL of water. After stirring, a few drops of 20% HF solution were added to remove any cloudiness, and the resulting solution was placed in an Amicon filtration unit containing a filter designed to pass materials having a molecular weight<3,000 g/mol. The solution was diluted to 200 mL and then purified by ultrafiltration, which resulted in a final volume of 35 mL in volume. Inductively coupled plasma-atomic emission spectroscopy showed that the final solution was 456 mM in Si.

### Example 6

A precursor solution useful for preparing silicon-carbide-embedded CNT composite fibers was prepared as follows: 8 g of water glass (50 wt % sodium silicate in water) was added to 30 mL of water. PEI (7 g) was then added and the solution mixed until the PEI dissolved. The solution was placed in an Amicon filtration unit containing a filter designed to pass materials having a molecular weight<3,000 g/mol. The solution was diluted to 200 mL and then concentrated to approximately 50 mL in volume; this procedure was repeated 5 times to remove the sodium. Inductively coupled plasma-atomic emission spectroscopy showed that the final solution was 473 mM in Si.

### Example 7

A precursor solution useful for preparing tungsten carbide-embedded CNT composite fibers was prepared as follows: An amount of 7.0 grams of polyethylenimine was dissolved in 70 mL of water. An amount of 8 g of sodium tungstate was added and the resulting solution was titrated to pH 4 using 10% HCl. The resulting solution was stirred, then filtered through CELITE® and diatomaceous earth, and then placed in an Amicon filtration unit containing a PM 10 filter designed to pass materials having a molecular weight<10,000 g/mol. The solution was diluted to 200 mL and then purified by untrafiltration which resulted in concentrating the solution to a volume of 80 mL. This process was repeated three times to remove the unwanted sodium. Inductively coupled plasma-atomic emission spectroscopy showed that the final was 257 mM in W.

Another aspect of this invention relates to another composite structure including carbon nanotubes and metal carbide that takes the form of a sheet that includes ribbons of aligned carbon nanotubes in contact with metal carbide. An embodiment includes niobium carbide (NbC), which is known for its high melting point (3490° C.), high hardness, excellent chemical stability [18, 19], and superconductivity at transition temperatures of 6.0-12.0 K [18, 20, 21]. The superconducting transition temperature (T_{c}) of NbC is very sensitive to impurities and carbon vacancies. A variety of approaches have been used to improve the superconducting properties of niobium carbide [18, 20-22] but the high processing temperature (1400-2000° C.) at which NbC can be formed makes it difficult to fabricate NbC with desired properties.

An aspect of this invention relates to composite structures that integrate CNT ribbons with epitaxial superconducting NbC films. These composites provide an enhanced conductivity along the CNT axial direction and an improved upper critical field of the superconducting NbC. Results from nanomechanical testing of these structures demonstrate a potential for enhanced fracture toughness.

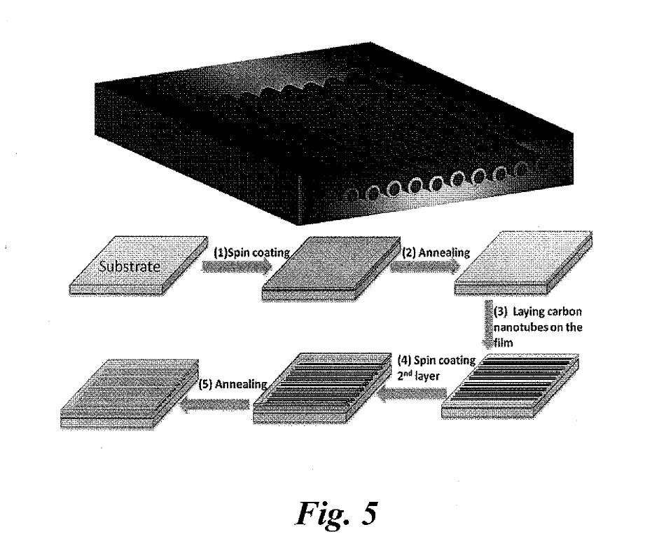

FIG. 5 provides a schematic representation for the preparation of an embodiment NbC/CNT composite. Briefly, a precursor Nb solution prepared according to Example 2 was spin-coated on a single crystal c-cut Al₂O₃ substrate. The Nb precursor solution was prepared by mixing NbCl (2 g) with NH₄OH, purified water (30 ml), 20% HF (7.5 ml), and polyethyleneimine (PEI) (3.0 g). The precursor film was subsequently annealed in ethylene at a temperature of 650° C. for 2 hours, and then in forming gas (Ar/6% H₂) at a temperature of 1000° C. for 4 hours. Following that, CNT ribbon directly drawn out from a highly aligned CNT array was laid on the surface of the NbC film. The highly-aligned CNT array with a height about 600 μm was synthesized at 750° C. with 140 sccm forming gas (Ar with 6% H₂) and 30 sccm ethylene for 12 min [23]. The precursor Nb solution was again spin-coated on the top of the CNT ribbon and annealed using the same processing parameters as described above. It should be noted that the aligned CNT ribbon could move around during the spin-coating process. In order to immobilize the CNTs on the surface and maintain their alignment, the CNT ribbon was pretreated with a surfactant solution before applying the second precursor Nb solution. Both the chemistry and the annealing temperature used to form epitaxial NbC were completely compatible with the CNT inclusions. In other words, ethylene has been used as the carbon source to synthesize both the NbC and the CNT array, and annealing the CNT array at 1000° C. in forming gas (Ar+6% H₂) does not destroy CNTs.

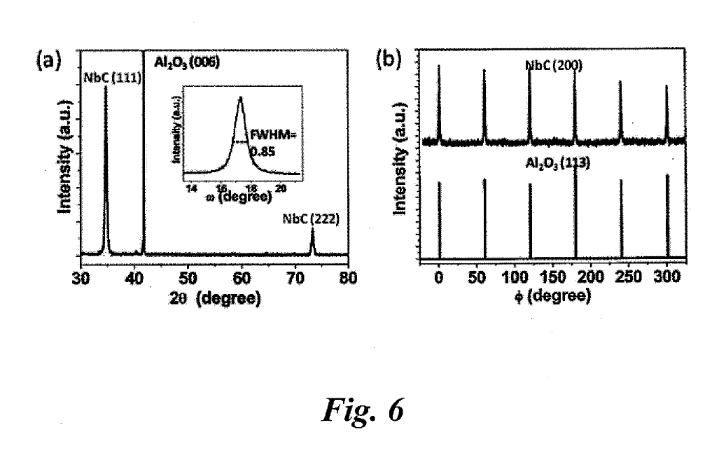

The NbC on the c-cut Al₂O₃ substrate was epitaxial as demonstrated by XRD patterns from in-plane and out-of-plane scans. FIG. 6a shows the 0-20 scans of the NbC/CNT film. The NbC is preferentially oriented with (111) direction perpendicular to the substrate surface. The disappearance of CNT peaks from X-ray diffraction can be attributed to the small quantity of CNTs in the composite structure. The full width at half maximum of the (111) rocking curve is 0.85°, indicating that the NbC is well oriented normal to the substrate surface even with the inclusion of CNTs. The in-plane orientation of the NbC/CNT composite film with respect to the major axes of the c-cut Al₂O₃ substrate is measured by XRD φ-scans on both the NbC (200) and the Al₂O₃ (113) reflections. As shown in FIG. 6b, six peaks separated by 60° from the (200) reflections of NbC align perfectly with the peaks from (113) reflections of Al₂O₃, showing that the NbC is epitaxial with respect to the substrate. Considering the crystal structure and the lattice parameters of NbC (cubic, a=0.447 nm) and Al₂O₃ (rhombohedral, a=0.476 nm), this orientation relationship gives the smallest lattice misfit at the interface between the (111) oriented cubic NbC and the c-cut Al₂O₃.

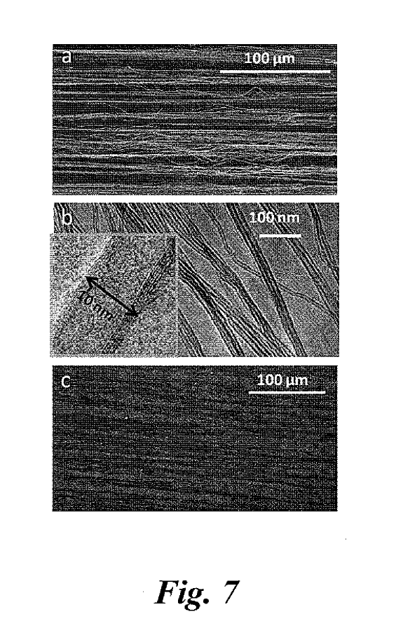

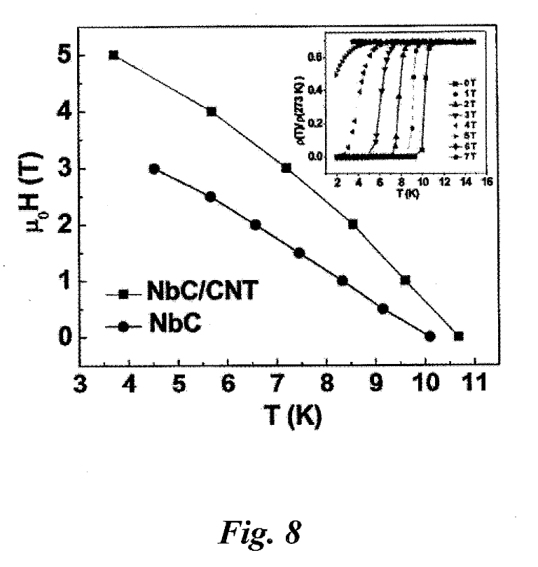

The full integration of the CNT ribbon with the NbC film has been confirmed by the analysis of the micro-/nano-structure of the composite structure. FIG. 8a shows a top view SEM image of the aligned CNT ribbons, which were directly drawn from a well-aligned multi-walled CNT array. As shown in FIGS. 7a and 7b, the CNTs in the ribbon are macroscopically parallel to each other along the drawing direction, with partially wavy structures observed at a microscopic scale. Furthermore, as can be seen in FIG. 3b, the surfaces of the CNTs are very clean without any observable amorphous carbon. A high-resolution TEM image (inset in FIG. 7b) shows that the CNTs have an average diameter around 10-nm with from 4 to about 6 walls. FIG. 7c is a top view SEM image of the composite structure. Although the CNTs are embedded in the NbC film, the SEM is still very sensitive to the presence of CNTs. Comparing FIGS. 7a and 7c, one can clearly see that the aligned CNT ribbons are well retained after the spin-coating of Nb precursor solution and the high-temperature annealing process to convert the precursor into an epitaxial NbC matrix.

The enhanced superconducting properties of epitaxial NbC/CNT composite structures in comparison with pure epitaxial NbC films are demonstrated by the upper critical field (H_{c2}, the field above which the material goes into the normal state). FIG. 8 shows the H_{c2} (the external magnetic field H is normal to the film surface) as a function of temperature for both the pure epitaxial NbC and the NbC/CNT composite films. The inset in FIG. 8 shows the normalized resistivity at different magnetic fields as a function of temperature for a typical NbC/CNT composite film. The Hₐ is defined as the onset field at which the ratio ρ/ρ_{N}=95%, where ρ_{N} is the normal state resistivity right above the transition temperature. A value of H_{c2} over 4.5 T at 4.2 K for the epitaxial NbC/CNT composite, to the best of our knowledge, is the highest reported value for NbC films. The Hₐ of the pure epitaxial NbC film with a similar transition temperature is 30% lower compared to the NbC/CNT composite. The much enhanced H_{c2} (H_{c2}=Φ₀/2πξ²) in the NbC/CNT composite, where (Φ₀=hc/2e˜2×10⁻⁷ Gcm² is the flux quantum, indicates that the inclusion of CNT ribbons in the epitaxial NbC matrix effectively reduces the coherence length (ξ) of NbC. It should be noted that the values of H_{c2} are quite similar when the field is either perpendicular or parallel to the film surface, which is in contrast with the anisotropic H_{c2} observed from bulk NbC/CNT composites [24]. In addition, the superconducting transition temperature (Tₑ) is slightly higher for the NbC/CNT composite film compared with a controlled pure NbC film. Typically, the T_{c} of NbC/CNT is around 10.5 K or above, while that of pure NbC films made by polymer assisted deposition (PAD) with the same processing conditions is in the range of 7-10 K. It is known that the Tₑ of NbC is sensitive to changes in the C/Nb ratio, defects, and impurities. The embodiment NbC/CNT film has been annealed at a temperature of 1000° C., so carbon atom from the outer walls of the CNTs could contribute to a higher carbon content, which could result in a slightly higher Tₑ.

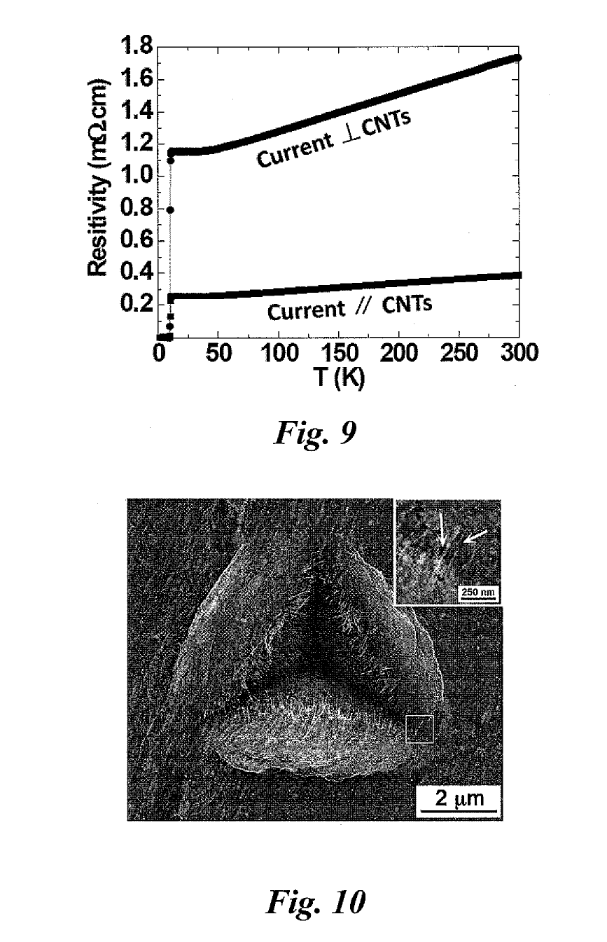

Another effect of the inclusion of a CNT ribbon in an epitaxial NbC matrix is the reduction of normal state resistivity of the composite along the CNT axial direction. CNT ribbons are highly aligned in the composite film. FIG. 9 shows the resistivity vs. temperature characteristics of the NbC/CNT composite film when the current is flowing either normal or parallel to the CNT axial direction. The resistivity of the NbC/CNT composite film along the CNT axial direction is four times lower than the resistivity normal to the CNT axial direction at 300 K. The anisotropic resistivity of the NbC/CNT film at the normal state indicates that one can further manipulate the electrical properties of the NbC/CNT assembly by optimizing either the amount of CNT ribbons in the composite or the length of CNTs.

FIG. 10 is a SEM micrograph of the film after nano-indentation with a BERKOVICH pyramidal diamond indenter to a depth of one micron. The micrograph shows that the film has fractured and the CNTs protrude from the fracture surface at the edge of the film. A closer look at the corner of the indent as shown in the inset reveals evidence of CNTs bridging the propagating crack. Control of crack bridging as well as fiber pull-out is a known mechanism for enhanced toughness of fiber-reinforced composites. While the efficacy depends on the matrix-fiber bonding strength, which is not quantified here, it does show the potential for enhancing fracture toughness through control of the fiber-matrix bond strength via different processing routes or use of different surfactants on the CNTs prior to embedding in the NbC matrix.

### REFERENCES

The following references are incorporated by reference herein.
[1] Dumitrica et al., “Symmetry-, time-, and temperature-dependent strength of carbon nanotubes,” Proc. Natl. Acad. Sci. USA, April 2006, vol. 103, pp. 6105-6109.
[2] Treacy et al., “Exceptionally high Young's modulus observed for individual carbon nanotubes,” Nature, June 1996, vol. 381, pp. 678-680.
[3] Zhang et al., “Strong Carbon-Nanotube Fibers Spun from Long Carbon-Nanotube Arrays,” Small, January 2007 online, vol. 3, pp. 244-248.
[4] Liu et al., Adv. Mater. “Synthesis of Macroscopically Long of Well-Aligned Single-Walled Carbon Nanotubes,” August 2000 vol. 12, pp. 1190-1192.
[5] Li et al., Science, “Direct Spinning of Carbon Nanotube Fibers from Chemical Vapor Deposition Synthesis,” March 2004 online, vol. 304, pp. 276-278.
[6] Ericson et al, “Macroscopic, Neat, Single-Walled Carbon Nanotube Fibers,” Science, September 2004, vol. 305, pp. 1447-1450.
[7] Li et al., “Structure-Dependent Electrical Properties of Carbon Nanotubes,” Adv. Mat., 2007, vol. 19, pp. 3358-3363.
[8] Xu et al., Nano Lett., Bone-Shaped Nanomaterials for Nanocomposite Applications,” July 2003 online, vol. 3, pp. 1135-1139.
[9] Dalton et al., “Super-tough carbon nanotube fibers,” Nature, June 2003, vol. 423, p. 703
[10] Miaudet et al., “Hot-Drawing of Single and Multiwall Carbon Nanotube Fibers for High Toughness and Alignment,” Nano Lett., November 2005, vol. 5, pp. 2212-2215.
[11] Munoz et al., “Highly Conducting Carbon Nanotube/Polyethyleneimine Composite Fibers,” Adv. Mat., April 2005, vol. 17, pp. 1064-1067.
[12] Török et al., “Young's Modulus of TiN, TiC, ZrN, and HfN,” Thin Solid Films, 1987, vol. 153, pp. 37-43.
[13] Zheng et al., “Carbon-Nanotube Cotton for Large-Scale Fibers,” Adv. Mat. August 2007, vol. 19, pp. 2567-2570.
[14] Hollander, “Electrical Conductivity and Thermoelectric Effect in Single-Crystal TiC, J. Appl. Phys., 1961, vol. 32, pp. 996-997.
[15] H. R. Zeller, “Electrical Conductivity of One-Dimensional Conductors,” Phys. Rev. Lett., 1972, vol. 28, pp. 1452-1455.
[16] M. F. Matare, “Carrier Transport at Grain Boundaries in Semiconductors,” J. Appl. Phys., 1984, vol. 56, pp. 2605-2632.
[17] Li et al., “Structure-Dependent Electrical Properties of Carbon Nanotube Fibers,” Advanced Materials, 2007, vol. 19, pp. 3358-3363.
[18] Giorgi et al., “Effect of Composition on the Superconducting Transition of Tantalum Carbide and Niobium Carbide,” Phys. Rev. (1962), vol. 125, pp. 837-838.
[19] Adamovskii, “Carbides of Transition Metals in Abrasive Machining (Review),” Power Metall. Met. Ceramics, (2007), vol. 46, pp. 595-607
[20] Gusev et al., “Superconductivity in Disordered and Ordered Niobium Carbide,” Phys. Stat. Sol. (b), (1989), vol. 151, pp. 211-224.
[21] Pechen et al., “Tunneling and critical-magnetic-field study of superconducting NbC thin films,” Physica C, (1994), vol. 235, pp. 2511-2512.
[22] Geerk, “The superconducting transition temperature of niobium carbide single crystals after implantation of light elements,” Radiation Effects, (1980), vol. 48, pp. 35-36
[23] Zhang et al., “Tailoring the Morphology of Carbon Nanotube Arrays: From Spinnable Forests to Undulating Foams,” ACS Nano, August 2009 (July 2009 online), vol., 3, pp. 2157-2162
[24] Zou et al., “Highly aligned carbon nanotube forests coated by superconducting NbC,” Nature Communications, August 2011, pp. 1-5.

What is claimed is:

1. A composite structure comprising a solid mixture of aligned multiwalled carbon nanotubes and metal carbide.

2. The composite structure of claim 1, wherein said composite structure comprises a helical fiber comprising helically aligned multiwalled carbon nanotubes and metal carbide.

3. The composite structure of claim 2, wherein the metal carbide is titanium carbide.

4. The composite structure of claim 1, wherein said composite structure comprises a plurality of ribbons of horizontally aligned carbon nanotubes, said ribbons oriented parallel to each other and embedded in a layer of metal carbide.

5. The composite structure of claim 4, wherein the metal carbide is niobium carbide.

6. A composite structure of multiwalled carbon nanotubes and metal carbide, said composite structure prepared by a process comprising:
drawing carbon nanotubes from an array of substantially aligned carbon nanotubes while twisting the carbon nanotubes around each other to form a helical fiber,
coating the carbon nanotubes from the fiber with a homogeneous solution comprising a soluble metal precursor, a soluble polymer selected from a polyethyleneimine and derivatives of polyethyleneimine, and a suitable solvent, the soluble metal precursor including a metal selected from titanium, zirconium, hafnium, vanadium, niobium, tantalum, chromium, molybdenum, tungsten, scandium, yttrium, aluminum and silicon, the soluble polymer binding to the soluble metal precursor, and thereafter
heating the fiber in a reducing atmosphere that includes a carbon source gas at temperatures and for times characterized as sufficient to remove the polymer and form a composite structure of multiwalled carbon nanotubes and metal carbide, said composite structure comprising a composite helical fiber of carbon nanotubes and metal carbide.

7. The composite structure of claim 6, wherein the coating the carbon nanotubes from a homogeneous solution comprising soaking the fiber in the homogeneous solution.

8. The composite structure of claim 7, wherein the process for forming said structure further comprises forming a homogeneous solution by mixing together a soluble polymer selected from polyethyleneimine and polyethyleneimine derivatives, a soluble metal precursor, and a suitable solvent to form a first solution and then purifying the first solution by ultrafiltration to form the homogeneous coating solution.

9. The composite structure of claim 6, wherein the carbon gas source is ethylene.

10. The composite structure of claim 6, wherein the reducing atmosphere comprises forming gas.

11. A process for forming a composite structure, comprising:
drawing carbon nanotubes from an array of substantially aligned carbon nanotubes while twisting the carbon nanotubes around each other to form a helical fiber,
coating the carbon nanotubes from the fiber with a homogeneous solution comprising a soluble metal precursor, a soluble polymer selected from a polyethyleneimine and derivatives of polyethyleneimine, and a suitable solvent, the soluble metal precursor including a metal selected from titanium, zirconium, hafnium, vanadium, niobium, tantalum, chromium, molybdenum, tungsten, scandium, yttrium, boron, aluminum and silicon, the soluble polymer binding to the soluble metal precursor, and thereafter
heating the fiber in a reducing atmosphere that includes a carbon source gas at temperatures and for times characterized as sufficient to remove the polymer and form a structure comprising a composite helical fiber of carbon nanotubes and metal carbide.

12. The process of claim 11, wherein the coating the carbon nanotubes from a homogeneous solution comprising soaking the fiber in the homogeneous solution.

13. The process of claim 11, wherein the process for forming said structure further comprises forming a homogeneous solution by mixing together a soluble polymer selected from polyethyleneimine and polyethyleneimine derivatives, a soluble metal precursor having a metal selected from scandium, yttrium, titanium, zirconium, hafnium, vanadium, niobium, tantalum, chromium, molybdenum, tungsten, boron, aluminum and silicon, and a suitable solvent to form a first solution and then purifying the first solution by ultrafiltration to form the homogeneous coating solution.

14. The process of claim 11, wherein the carbon gas source is ethylene.

15. The process of claim 11, wherein the metal carbide comprises titanium carbide.

16. The process of claim 11, wherein the reducing atmosphere comprises forming gas.
